(19) United States
(12) Patent Application Publication
(10) Pub. No.: US 2023/0148161 A1
(43) Pub. Date: May 11, 2023

(54) Cable Tray

(71) Applicant: ABB Schweiz AG, Baden (CH)

(72) Inventors: Daniel Lalancette, Saint-Jean-sur-Richelieu (CA); Jean-Michel Pelletier, Saint-Jean-sur-Richelieu (CA)

(73) Assignee: ABB Schweiz AG, Baden (CH)

(21) Appl. No.: 17/982,580

(22) Filed: Nov. 8, 2022

(30) Foreign Application Priority Data
Nov. 8, 2021 (CA) 3138070

(51) Int. Cl. F16L 3/26; H02G 3/04

(52) U.S. Cl. CPC F16L 3/26; H02G 3/0456

(57) ABSTRACT

A cable tray includes a pair of opposed side rails. Each of the pair of side rails includes an upper flange and a lower flange. A web portion extends between and interconnects the upper flange and the lower flange. The web portion includes an outer side and an inner side and a plurality of stiffeners protrude one or more of inwardly and outwardly therefrom. A plurality of spaced apart rungs extend between and connect the pair of opposed side rails.

### CROSS-REFERENCE TO RELATED APPLICATIONS

This patent application claims priority to Canadian Patent Application No. 3,138,070, filed on Nov. 8, 2021, which is incorporated herein in its entirety by reference.

### FIELD OF THE DISCLOSURE

The present disclosure relates to systems and devices for supporting cables, in particular, cable trays for supporting electrical and other types of conduits.

### BACKGROUND

Cable trays are used in buildings and other structures for supporting cables and other conduits. In modern facilities, where it is less common to run cables and the like inside of building walls, cable trays are useful in organizing and routing electrical power, signal, other cables, and other conduits such as tubing and piping, for example. Cable trays are configured to support the running of cables throughout a facility and are typically attached to walls or suspended from ceilings of the facility in order to provide easy access to the cables while keeping them from interfering with operations within the facility.

In commercial facilities, designed for manufacturing for example, the combined weight of electrical and signal cables and other conduits can be substantial. While cable trays must be able to support the weight of cables that they carry, it would be desirable to do so without using unnecessarily costly amounts of material in constructing the trays. There is a need for an improved construction of cable trays. Devices and methods according to the disclosure satisfy the need.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### BRIEF SUMMARY OF THE DISCLOSURE

Aspects of the disclosure include a pair of opposed side rails. Each of the pair of side rails includes an upper flange and a lower flange. A web portion extends between and interconnects the upper flange and the lower flange. The web portion includes an outer side and an inner side and a plurality of stiffeners protrude one or more of inwardly and outwardly therefrom. A plurality of spaced apart rungs extend between and connect the pair of opposed side rails.

Another aspect of the disclosure includes a method of making a cable tray, which includes forming a plurality of rungs, forming a pair of rails, each of the rails having an upper flange, a lower flange, and a web portion extending between and interconnecting the upper flange and the lower flange. The web portion includes an outer side and an inner side. A plurality of stiffeners are formed in the web portion. The plurality of rungs are interposed between the pair of rails and the rungs are connected to the pair of rails to form the tray.

### BRIEF DESCRIPTION OF THE SEVERAL VIEWS OF THE DRAWINGS

FIG. 1 is a perspective view of conventional cable tray.

FIG. 2 is a perspective view of a cable tray according to the disclosure with convexities.

FIG. 3 is a side view of the cable tray of FIG. 2.

FIG. 4 is an end view of the cable tray of FIG. 2.

FIGS. 5-15 are perspective views of cable trays with alternative embossments.

FIG. 16 is a perspective view of a cable tray according to the disclosure with corrugated flanges.

FIG. 17 is a cross section view of an embodiment of the flange of FIG. 16.

FIG. 18 is a flowchart illustrating a method of making a cable tray.

### DETAILED DESCRIPTION

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings. For purposes of description herein, the terms “upper”, “lower”, “left”, “rear”, “right”, “front”, “vertical”, “horizontal”, and derivatives thereof shall relate to the invention as oriented in the figures. Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings. Use of the term “configured” is intended to refer to the shape and size of a structural element.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

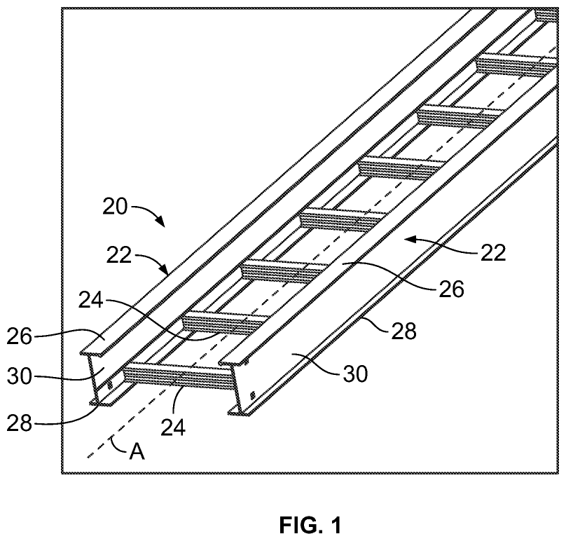

FIG. 1 shows a conventional cable tray 20, which includes a ladder-like configuration, with two opposed, parallel and elongate rails 22 that are interconnected via a plurality of spaced apart rungs 24. The rungs 24 are typically oriented transversely relative to the rails and normal to the longitudinal axis “A” of the tray 20. The rungs 24 may be cylindrical, square, rectangular, or any suitable shape. Typically, the rungs are welded to the rails, but other methods of attachment are known including the use of clips, as is known. It will be understood that the following figures will illustrate only portions of the same basic cable tray, with modifications to aspects thereof from that shown in FIG. 1. For clarity, every alternative will not be shown in a complete cable tray assembly, and it will be understood that such modified parts are substituted for those general elements appearing in FIG. 1.

Each of the rails 22 includes an upper flange 26 and a lower flange 28. The flanges 26, 28 are interconnected by and spaced apart by a web 30. Typically, the flanges 26, 28 are oriented in a generally horizontal plane when the cable tray 20 is installed in a facility and typically extend inwardly and outwardly from the web 30, which is oriented in a generally vertical plane. Both flanges 26, 28 are generally planar, rectangular plates, made of any suitable material, such as steel, aluminum, or other metallic materials, and plated/coated metals, or, in the alternative, composites such as fiberglass. It is more common, however, that the material forming the tray 20 is electrically conductive so that the tray can be grounded. The web 30 of each of the rails 22 is a planar, rectangular plate and may be made of the same material or materials as the flanges. The web 30 may be a solid piece, uninterrupted by openings with exceptions being made for means to join trays together with fasteners, for example, or for ventilation or other functionality.

Each rail 22 therefore includes a pair of spaced flanges 26, 28 interconnected by a web 30 extending therebetween. The rails 22 may be extruded or otherwise formed as a one-piece construction or formed as separate pieces by extrusion or rolling, for example, and joined together by welding, for example. Commonly, cable trays 20 are manufactured in lengths which are joined together to form long runs or cut to desired lengths to form a desired configuration for a specified installation.

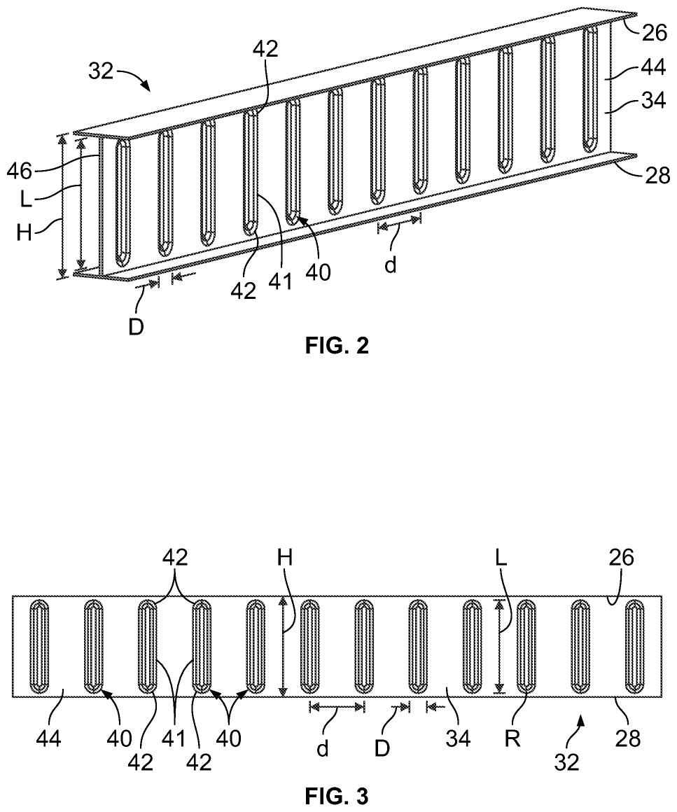

FIGS. 2-4 show a rail 32 for a cable tray that has been modified from that shown in FIG. 1 to provide an increase in resistance to torsional forces resulting from loading the cable tray. Due to the construction of cable trays 20, each rail 32 tends to respond to loading by twisting inwardly. A deflection including such a twist is known as torsion. As a result of the modification illustrated in FIGS. 2-4, and the following alternatives, to the shape of the web portion 34 of the rail 32, which increases resistance to torsion, less material can be used in the web portion 34. In this example, all other features of a cable tray remain unchanged and only the web portion 34 is modified from the original configuration.

In this embodiment, the rail 32, including an initially generally flat web portion 34, may be formed by extrusion or any suitable method such as roll forming, laser cutting, punching, hydroforming, bending, and so on. Subsequently, after initial forming of a blank or work piece, the rail 32 is placed in or passed through a die or otherwise formed into the final configuration shown. The cold forming process may involve a single cold forming operation or may involve progressive methods. Similar methods may be employed in making all of the embodiments disclosed herein including the rungs and flanges.

The rail 32, after forming, is provided with a plurality of stiffeners 40 arranged with a main axis oriented generally vertically in the web. Alternatively, the stiffeners 40 may be inclined from the vertical orientation. Each of the stiffeners 40 has a shape including a semi-cylinder portion 41 with rounded ends 42 and a length (L) that spans more than half the distance between the flanges 26, 28. In embodiments, the length L is about 90 percent of the distance between the flanges 26, 28. In one example, where the rail 32 is about seven inches in height (H), the stiffeners 40 are about six inches in length L, about one inch in diameter (D) and the rounded transitions 42 at the end and sides of the stiffeners have a radius (R) of about ½ inch. In embodiments, the radius R of the semi-cylinder portion 41 is about ½ inch. In embodiments, the stiffeners have a height from about 40% to about 95% that of the web. In embodiments, the height H of the rail 32 is from about two inches to about eight inches.

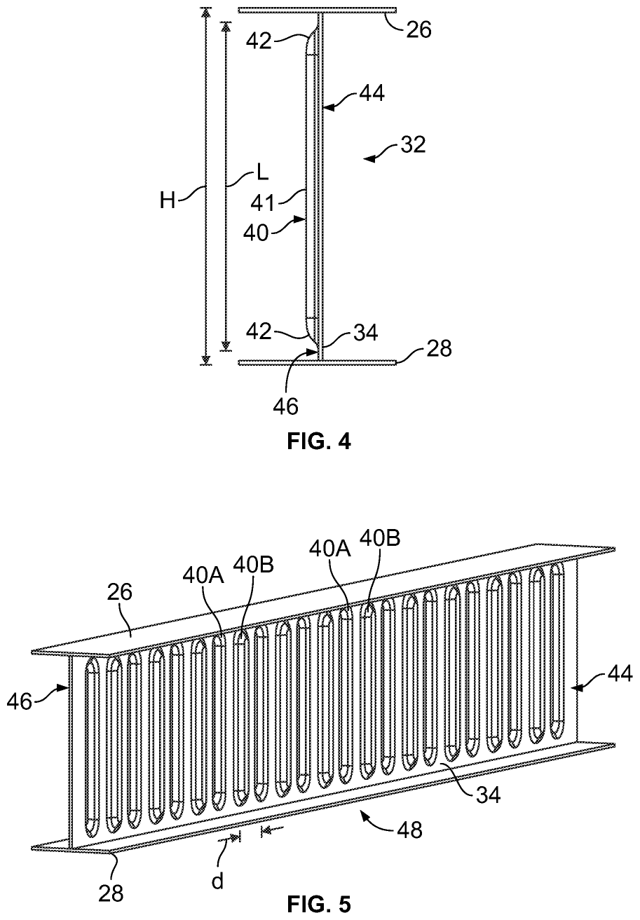

In the illustrated rail 32, all of the stiffeners 40 protrude only from an outer side 46 of the web portion 34 as best seen in FIG. 4. While forming stiffeners to protrude from the inner side 44 is also contemplated or both sides, it is believed that a greater stiffening effect may be realized from forming the stiffeners 40 to protrude from the outer side 46.

Furthermore, for purposes of the disclosure, reference to a feature or element protruding from the outer side or inner side will be used to refer to a stiffener or parts of a stiffener that has structural aspects that extend in a direction relative to the plane of the generally flat or planar portion of the web 34. It will be understood, that stiffeners 40, and all of the embodiments of stiffeners disclosed herein are features that are formed from original web material, not material that is added to the original material of the web. Accordingly, the stiffeners 40, and all of the stiffeners disclosed herein have a concave or negative side 43 and a corresponding convex or positive side 45. In the instant embodiment of FIGS. 2-4, stiffeners 40 have a convex, positive extending rib shape extending outwardly from the outer side 46 and a corresponding concave, negative extending rib shape formed in the inner side 44 of the web 34.

As shown in FIG. 5, stiffeners 40 may be formed to protrude from both the outer and inner side 46, 44. The stiffeners 40 may be spaced apart from each other longitudinally a distance (d) from about two to about three inches. The stiffeners 40 may also protrude from the plane of the web 34 about ½ inch. It will be understood that other spacing and dimensions of the stiffeners 40 are contemplated. In FIG. 5 stiffeners 40A protruding from outer side 46 are formed on the web 34 alternatingly with stiffeners 40B which protrude from the inner side 44 of rail 48. Other patterns are contemplated.

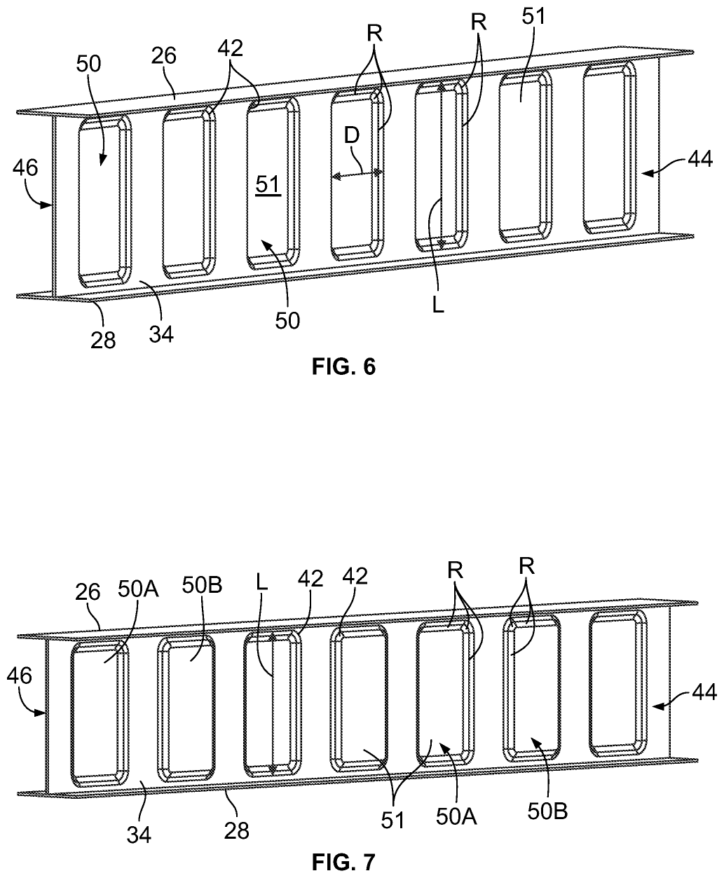

FIG. 6 and FIG. 7 show stiffeners 50 that are generally rectangular and have a greater diameter D relative to the stiffeners of FIGS. 2-5. For orientation, the upper and lower flanges 26, 28 are shown. The sides of the rectangular stiffeners 50 meet at corners 42 with, for example, a ½ radius R. The same radius R extends around the entire shape of each of the stiffeners 50 to define a central, rectangular planar surface 51. The stiffeners 50 may be more than one inch in diameter D, for example, from about two inches to about three inches in diameter. All of the stiffeners 50 in FIG. 6 protrude from the outer side 46 of the web 34. In contrast, the stiffeners 50A, 50B of FIG. 7, while having the same size and shape as those stiffeners 50 of FIG. 5, protrude alternatingly from the outer side 46 and the inner side 44 along the length of the web 34. The length L of the stiffeners 50A, 50B may be the same or similar to the length of the stiffeners of FIG. 3, for example.

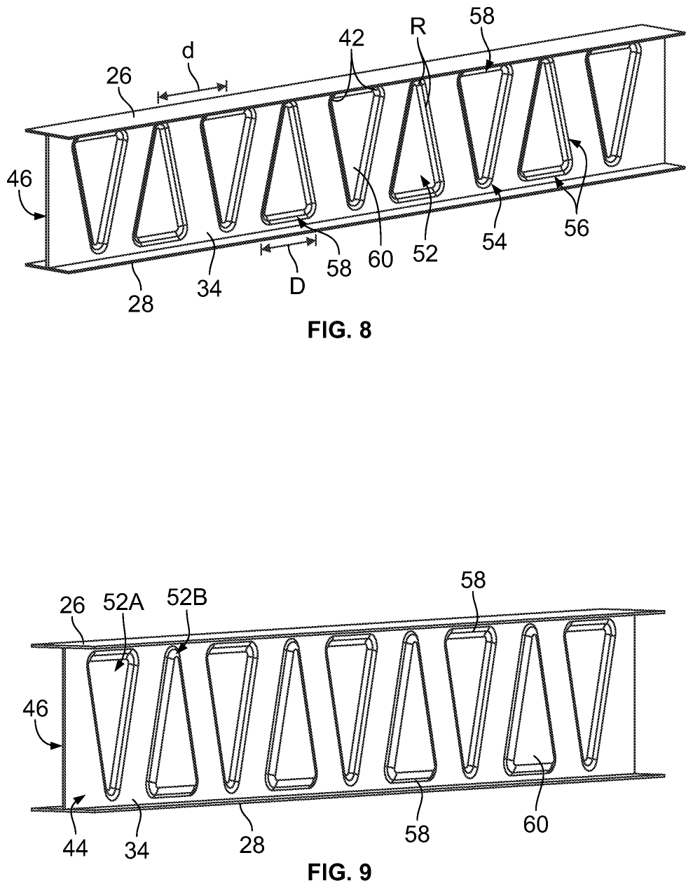

FIG. 8 and FIG. 9 show stiffeners 52 that are generally triangular with corners 54 and straight sides 56 rounded with a radius R of about ½ inch. The shape of the triangles may be that of an isosceles triangle. The stiffeners 52 have a base diameter D or base segment length and a length L similar to the stiffeners of FIG. 7. The stiffeners 52 may be from about two inches to about three inches in diameter D at the base of the triangle 58. A central, triangular planar surface 60 of each of the stiffeners 52 is defined between the base 58 and sides 56. The stiffeners 52 alternate in orientation with a first stiffener having its base 58 positioned adjacent the upper flange 26 and a second, adjacent stiffener 52 with its base 58 positioned adjacent the lower flange 28 and so on.

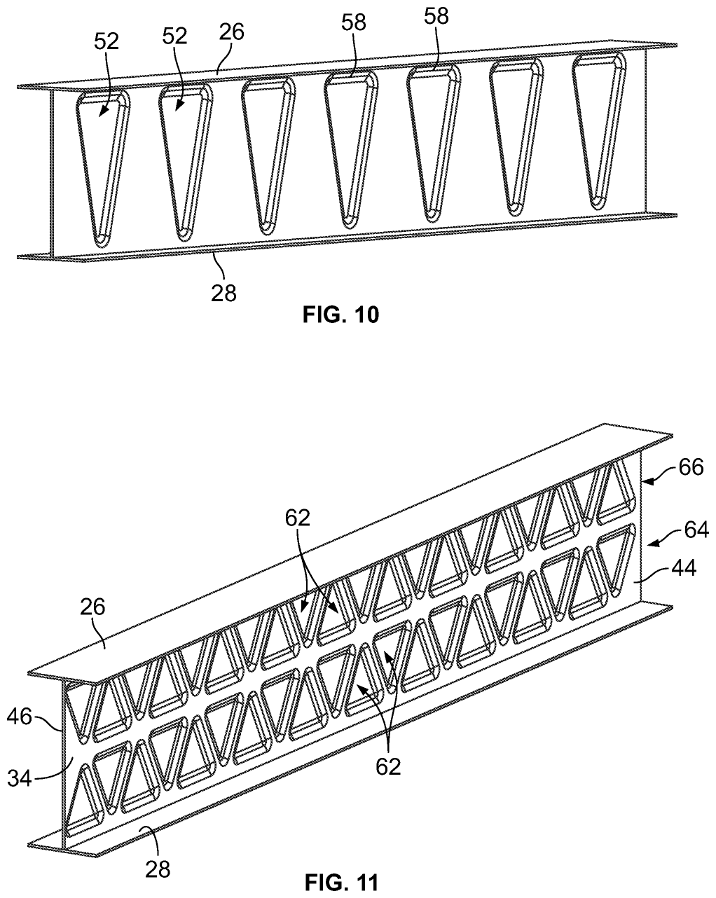

All of the stiffeners 52 in FIG. 8 protrude from the outer side 46 of the web 34. In contrast, the stiffeners 52A, 52B of FIG. 9, while having the same size and shape as those stiffeners 52 of FIG. 7, protrude alternatingly from the outer side 46 and the inner side 44. FIG. 10 shows stiffeners 52 which are the same in size and shape as those shown in FIG. 8, however all of the stiffeners 52 in FIG. 10 have base 58 positioned adjacent the upper flange 26.

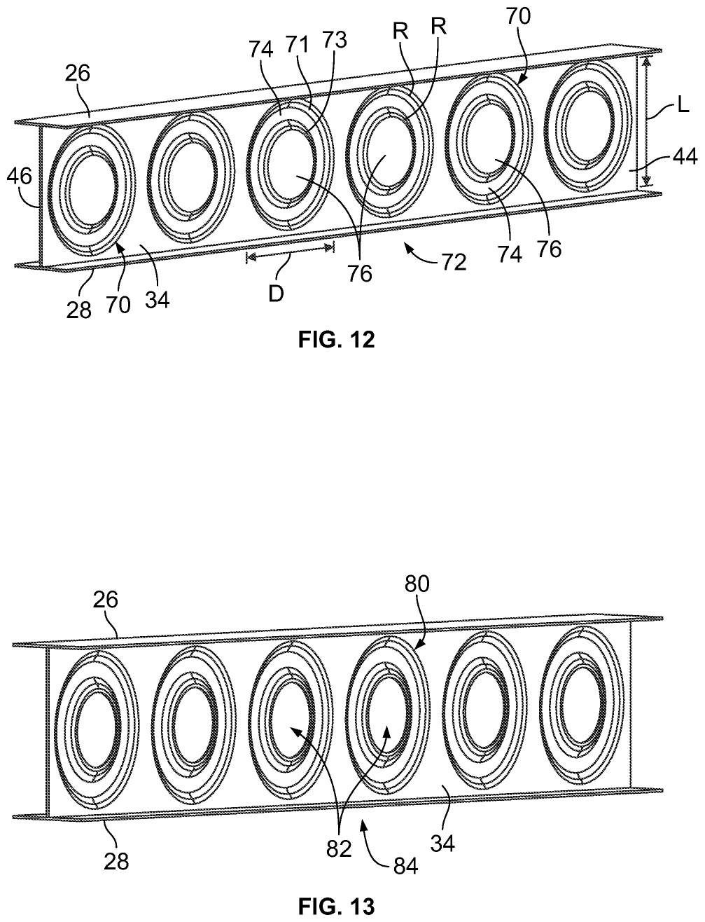

FIG. 11 includes stiffeners 62 which are arranged in web 34 in two rows. A first row 64 is positioned adjacent the lower flange 28 and below the second row 66 which is positioned adjacent the upper flange 26. Each of the rows 64, 66 includes triangular stiffeners 62 that protrude from the outer side 46. It will be understood that forming the stiffeners 62 to alternate in the direction of protrusion from the outer side 46 and the inner side 44 of the web 34 is contemplated as well as other patterns. To fit the stiffeners 62 into the two rows, the size of each stiffener may be about half that of the stiffeners that are sized to span most of the distance from the upper to the lower flange 26, 28 as is shown in FIG. 8, for example. In the illustrated example, adjacent stiffeners 62 in the first and second rows 64, 66 may be arranged as mirror opposites. It will be understood that the present disclosure contemplates any of the shapes of stiffeners arranged in one, two, or more horizontal rows.

FIG. 12 shows a set of circular stiffeners 70 arranged in a web 34 of rail 72. Stiffeners 70 have a vertical length L that may be equal to the horizontal diameter D. Accordingly, the stiffeners 70 are spaced apart so that there is web material 34 between each of the stiffeners, i.e., more than about seven inches apart center-to-center for example. Each of the stiffeners 70 includes a radius R of about ½ inch defining the outer edge 71 of the stiffener to form a flat annular panel 74 that protrudes relative the web portion 34 from the outer side 46. Inside the flat annular panel 74 is a radius R that is positioned at the inner edge 73 of the panel 74 and defines a circular panel 76 that protrudes inwardly relative to the flat annular panel 74.

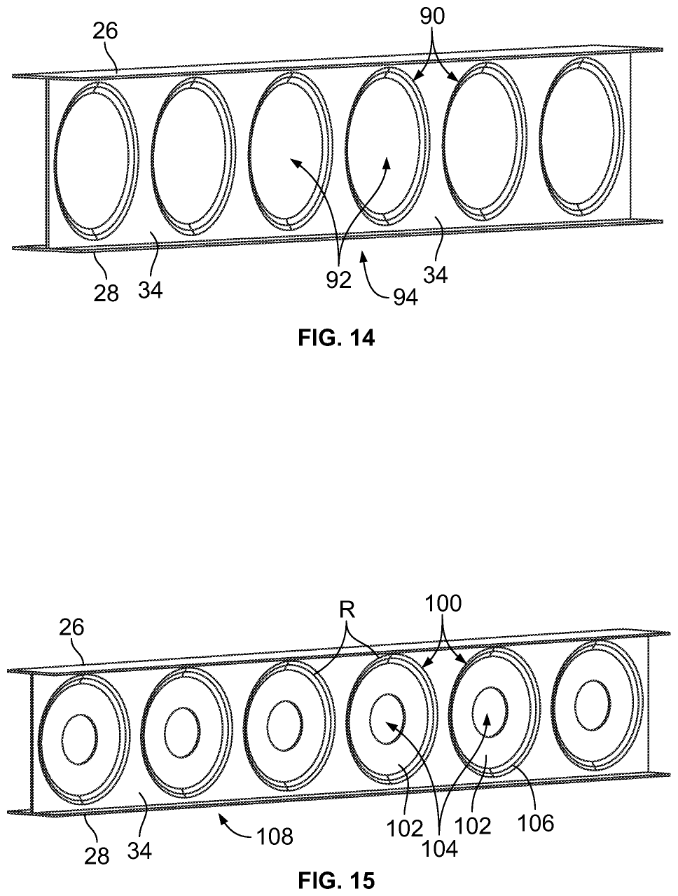

FIG. 13 shows a set of circular stiffeners 80 that are alike in size and shape to those shown in FIG. 12 except the material of the circular panel of FIG. 12 has been removed to provide a circular aperture 82. The circular aperture 82 may promote air circulation and lightens the weight of the rail 84.

FIG. 14 shows a set of circular stiffeners 90 that are alike in size and shape to those shown in FIG. 13 except the material of the annular panel of FIG. 12 has been removed to provide a circular aperture 92. The circular opening 84 may promote air circulation and lightens the weight of the rail 94.

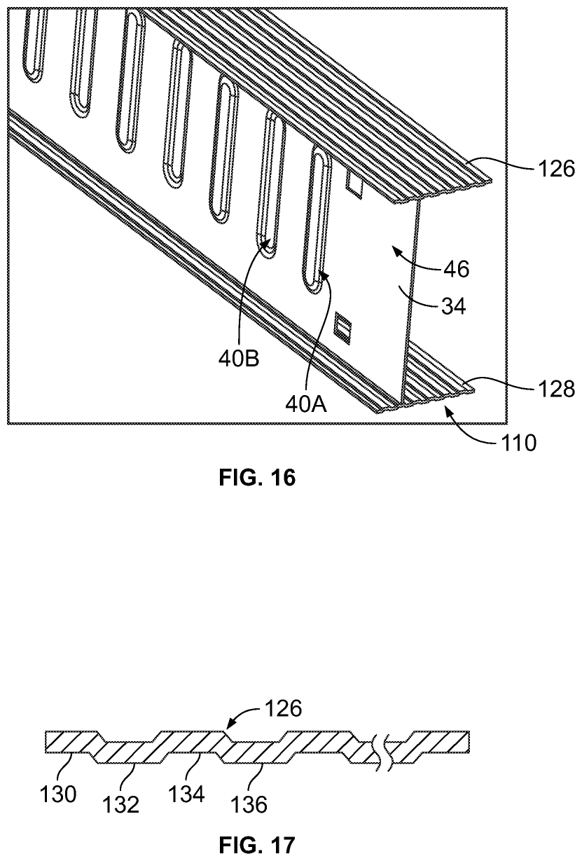

FIG. 15 shows a set of circular stiffeners 100 that are alike in size and shape to those shown in FIG. 14 except material extends from the radius R defining the outer edge 106 of the stiffener 100 inwardly to form an annular panel 102 with an aperture 104 formed at the center thereof. The opening 104 permits airflow and lessens the weight of the rail 108. It can be seen from the foregoing that protrusions of the rail web material that deviates from the plane of the web can function as stiffening features and may have a variety of geometric shapes, sizes, and orientations.

Turning to FIG. 16, a rail 110 is shown that has stiffening elements 40A, 40B from the embodiment described in connection with FIG. 5 formed in web 34. The upper flange 126 and lower flange 128 are formed with corrugations 130 to provide additional stiffening. The corrugations 130 may be formed by extruding the flanges 126, 128 or by passing a flat, featureless plate of material through a roller or other cold forming process. After forming the corrugations 130, the flanges 126, 128 may be welded to the web 34 to form a complete rail 110.

In cross section as seen in FIG. 17, the upper and lower flanges 126, 128 may be formed of a series of generally trapezoidal segments 130, 132, 134, 136 and so on joined at edges thereof to form a corrugated configuration. The corrugated configuration, i.e., the arrangement of the segments 130, 132, 134, 136 may form alternating ridges and grooves. The corrugated configuration may include bead ribs, pencil ribs, sine wave shapes, v-ribs, striated, fluted, and other alternating shapes, and combinations thereof. In the illustrated embodiment, a first one of the segments 130 is joined to a second one 132 of the segments such that the second segment 132 is positioned out of the plane of the first segment and closer to the web 34. The third segment 134 which is joined to the second segment 32, is positioned in the plane of the first segment 130. The fourth segment 136 is joined to the third segment 132 in the plane of the second segment 132 and so on. In embodiments, there are 13 segments that the upper flange 126 and 13 segments that form the lower flange 128. Other numbers of corrugations are contemplated.

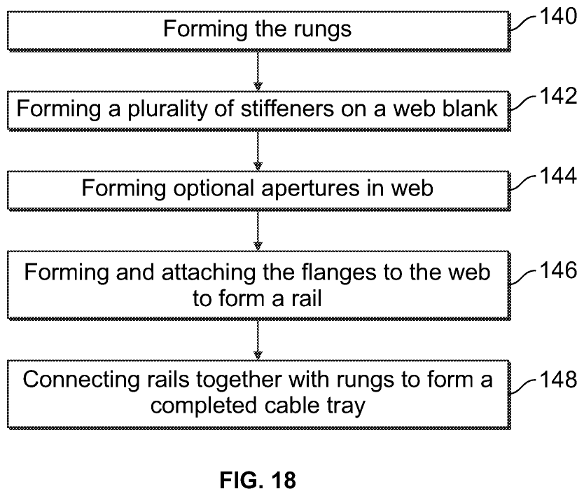

Methods of making a cable tray according to the disclosure are set out in FIG. 18. Also referring to FIGS. 1-17, rungs 24 are formed by extrusion or cold forming in step 140. The rungs may begin as an elongate extrusion that is subsequently cut into desired lengths. In step 142 a web blank or work-piece is formed by extrusion or cold forming and is modified by cold forming to form a plurality of stiffeners (one or more of 40, 42, 50 60, 70, 80, 90, 100) on the web 34. The cold forming may include placing the work piece into a flat die and stamping or passing the work piece through a set of correspondingly configured rollers that include the positive and negative shapes for producing the desired shape and spacing of stiffener features in the work piece. In an optional step 144, apertures (one or more of 82 92, 104) are formed in the web to remove material from the area of the web, including those areas with stiffeners. In step 146, upper and lower flanges (26, 28, 126, 128) are formed by extrusion or cold forming, for example, and are attached to the web 34 to form a rail (one or more of 32, 48, 72, 84, 94, 108, 110). Two rails (32, 48, 72, 84, 94, 108, 110) are attached to each other by attaching a plurality of rungs 24 therebetween by welding or any suitable method in step 148.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A cable tray, comprising:
a pair of opposed side rails, each of the pair of side rails comprising:
an upper flange;
a lower flange; and
a web portion extending between and interconnecting the upper flange and the lower flange, the web portion including an outer side and an inner side, and a plurality of stiffeners protruding one or more of inwardly and outwardly therefrom; and
a plurality of spaced apart rungs extending between and connecting to the pair of opposed side rails.

2. The cable tray of claim 1 wherein each of the stiffeners includes a concave side and a convex side.

3. The cable tray of claim 1 wherein the stiffeners protrude from the outer side of the web portion.

4. The cable tray of claim 1 wherein the stiffeners protrude from both the outer side of the web portion and the inner side of the web portion.

5. The cable tray of claim 4 wherein the stiffeners protrude from both the outer side of the web portion and the inner side of the web portion in an alternating pattern.

6. The cable tray of claim 1 wherein the stiffeners are arranged in a single row along the web portion or two rows along the web portion.

7. The cable tray of claim 1 wherein each of the stiffeners has a cylindrical shaped portion and opposed rounded shape end portions.

8. The cable tray of claim 1 wherein each of the stiffeners have a generally triangle shape.

9. The cable tray of claim 8 wherein each of the stiffeners have a generally isosceles triangle shape comprising a base segment.

10. The cable tray of claim 9 wherein the base segment of each of the stiffeners is positioned adjacent the lower flange or the base segment of each adjacent ones of the stiffeners alternate in position from being positioned adjacent the lower flange or positioned adjacent the upper flange.

11. The cable tray of claim 1 wherein each of the stiffeners has a generally rectangular shape.

12. The cable tray of claim 1 wherein each of the stiffeners has a generally circular shape.

13. The cable tray of claim 12 wherein an aperture is formed in a center of each of the generally circular stiffeners.

14. The cable tray of claim 13 wherein the aperture of each of the stiffeners is circular.

15. The cable tray of claim 1 wherein the upper flange and the lower flange includes corrugations.

16. The cable tray of claim 15 wherein the corrugations form alternating ridges and grooves.

17. The cable tray of claim 15 wherein the corrugations are one or more of wave, rectangular, trapezoidal, bead, or v-shaped.

18. A method of making a cable tray, comprising:
forming a plurality of rungs;
forming a pair of rails, each of the rails comprising an upper flange, a lower flange, and a web portion extending between and interconnecting the upper flange and the lower flange, the web portion including an outer side and an inner side;
forming a plurality of stiffeners in the web portion;
interposing the plurality of rungs between the pair of rails; and
connecting the rungs to the pair of rails.

19. The method of claim 18 wherein the rungs and rails are formed of a metallic material and said connecting comprises welding.

20. The method of claim 18 further comprising forming corrugations in one or both of the upper flange and the lower flange.
